(19) United States
(12) Patent Application Publication
(10) Pub. No.: US 2017/0291392 A1
(43) Pub. Date: Oct. 12, 2017

(54) ARTICLE HAVING LOW REFLECTION FILM

(71) Applicant: ASAHI GLASS COMPANY, LIMITED, Chiyoda-ku (JP)

(72) Inventor: Yohei KAWAI, Tokyo (JP)

(73) Assignee: ASAHI GLASS COMPANY, LIMITED, Chiyoda-ku (JP)

(21) Appl. No.: 15/480,872

(22) Filed: Apr. 6, 2017

(30) Foreign Application Priority Data
Apr. 7, 2016 (JP) 2016-077257

(51) Int. Cl. B32B 7/02; B32B 17/06; B32B 27/06; B32B 5/16

(52) U.S. Cl. CPC B32B 7/02; B32B 5/16; B32B 17/06; B32B 27/06; B32B 2307/418; B32B 2307/412; B32B 2309/105; B32B 2264/102

(57) ABSTRACT

Provided is an article having a low reflection film, containing a transparent substrate and a low reflection film provided on a surface of the transparent film. The low reflection film contains a first layer provided on the surface of the transparent substrate, a second layer contacting a surface of the first layer at the side opposite the transparent substrate, and a third layer contacting a surface of the second layer at the side opposite the first layer. The transparent substrate has a refractive index n0, the first layer has a refractive index n1, the second layer has a refractive index n2, and the third layer has a refractive index n3, and n0, n1, n2, and n3 satisfy the relationship n3<n1<n0<n2.

### TECHNICAL FIELD

The present invention relates to an article having a low reflection film.

### BACKGROUND ART

Projection apparatuses such as a projector, a head-up display and the like have been required to progress in high brightness. Furthermore, the projection apparatuses have been also required to reduce stray light caused by light reflected on the surface of an optical member inside the projection apparatuses, thermal load to other members, and the like. For this reason, for an optical member (e.g., an inorganic polarizing plate, etc.) of a projection apparatus, it is desired to provide a low reflection film with a wideband having low reflectance to each light of RGB.

The following has been proposed as a low reflection film for an optical member.

(1) A refractive index-gradient multilayered thin film containing at least three layers of thin film layer each having a transmittance in the whole visible light region of 70% or larger and having a thickness of 380 nm or smaller, in which the refractive index of each layer is gradually increased toward a substrate from an outermost surface layer (Patent Document 1).

In the low reflection film in (1) above, it is necessary to sufficiently decrease the refractive index of the outermost surface layer in order to sufficiently decrease the refractive index in the whole visible light region. In order to sufficiently decrease the refractive index of the outermost surface layer, specifically, it is necessary to increase the proportion of voids in the outermost surface layer. However, in the case where the proportion of voids in the outermost surface layer is increased, durability of the outermost surface layer is deteriorated. As a result, the outermost surface layer is liable to abrade by rubbing, leading to easy breakage by contact and the like.

The following article is, for example, proposed as an article having a low reflection film in which the refractive index of an outermost surface layer is relatively set high, thereby enhancing durability.

An article having a low reflection film, containing a transparent substrate and a low reflection film, in which the low reflection film contains a first layer, a second layer and a third layer arranged from a transparent substrate side in this order, and the refractive index n1 of the first layer, the refractive index n2 of the second layer and the refractive index n3 of the third layer satisfy the relationship of n2<n3<n1 (Patent Document 2).

Patent Document 1: JP-A-2007-052345

Patent Document 2: W02011/027827

### SUMMARY OF THE INVENTION

However, since the refractive index n3 of the third layer as the outermost surface layer is relatively high, the low reflection film of (2) may be insufficient in reduction of the reflectance in some cases.

The present invention provides an article having a low reflection film having low reflectance in the whole visible light region and high durability.

The present invention includes the following aspects.
(1) An article having a low reflection film, containing a transparent substrate and a low reflection film provided on a surface of the transparent film,

in which the low reflection film contains a first layer provided on the surface of the transparent substrate, a second layer contacting a surface of the first layer at the side opposite the transparent substrate, and a third layer contacting a surface of the second layer at the side opposite the first layer, and

in which the transparent substrate has a refractive index n0, the first layer has a refractive index n1, the second layer has a refractive index n2, and the third layer has a refractive index n3, and n0, n1, n2, and n3 satisfy the relationship n3<n1<n0<n2.
(2) The article having a low reflection film according to (1) above, in which each of the first layer, the second layer and the third layer has a film thickness of from 10 nm to 300 nm, and the low reflection film has a film thickness of from 100 nm to 700 nm.
(3) The article having a low reflection film according to (1) or (2) above, in which the refractive index n3 of the third layer is from 1.27 to 1.33.
(4) The article having a low reflection film according to any one of (1) to (3) above, in which the refractive index n1 of the first layer is from 1.35 to 1.47, and the refractive index n2 of the second layer is from 1.59 to 1.71.
(5) The article having a low reflection film according to any one of (1) to (4) above, in which the second layer contains SiO₂ and ZrO₂.
(6) The article having a low reflection film according to (5) above, in which the second layer has a matrix containing ZrO₂ and solid SiO₂ particles are dispersed therein.

The article of the present invention has a low reflection film having low reflectance in the whole visible light region and high durability.

### BRIEF DESCRIPTION OF THE DRAWINGS

FIG. 1 is a cross-sectional view illustrating one example of the article having a low reflection film according to the present invention.

FIG. 2 is a scanning electron micrograph showing a part of a cross-section of the article having a low reflection film according to the present invention.

### MODE FOR CARRYING OUT THE INVENTION

The following definitions of terms are applied over the present description and claims.

The term “transparent” means that an average transmittance of light having a wavelength of from 400 to 1,200 nm is 80% or larger. The term “visible light” means light having a wavelength of from 380 to 780 nm.

The term “layer containing SiO₂ as a main component” means that the proportion of SiO₂ in the layer (100 mass %) is 90 mass % or larger.

The term “layer consisting essentially of SiO₂” means a layer constituted of only SiO₂ except for unavoidable impurities.

The “burning” includes a curing treatment of heating a coating film obtained by applying a coating liquid to a transparent substrate.

The term “refractive index of each layer” is a refractive index of light having a wavelength of 550 nm determined by using an ellipsometer in a single layer film of each layer formed on a surface of a transparent substrate.

The term “film thickness of each layer” means a film thickness obtained by measuring film thicknesses at 10 places on an image obtained by observing a cross-section of an article having a low reflection film with a scanning electron microscope and averaging the film thicknesses at 10 places.

The term “average primary particle diameter of hollow SiO₂ particles” means an average particle diameter obtained by randomly selecting 100 particles from an image obtained by observing with a transmission electron microscope, measuring a particle diameter of each hollow SiO₂ particle, and averaging particle diameters of 100 hollow SiO₂ particles.

The term “average primary particle diameter of particles other than hollow SiO₂ particles” means an average particle diameter calculated by assuming that spherical particles are uniformly dispersed in a carrier, and converting from a specific surface area measured by BET method and a volume of spherical particles.

### (Article Having Low Reflection Film)

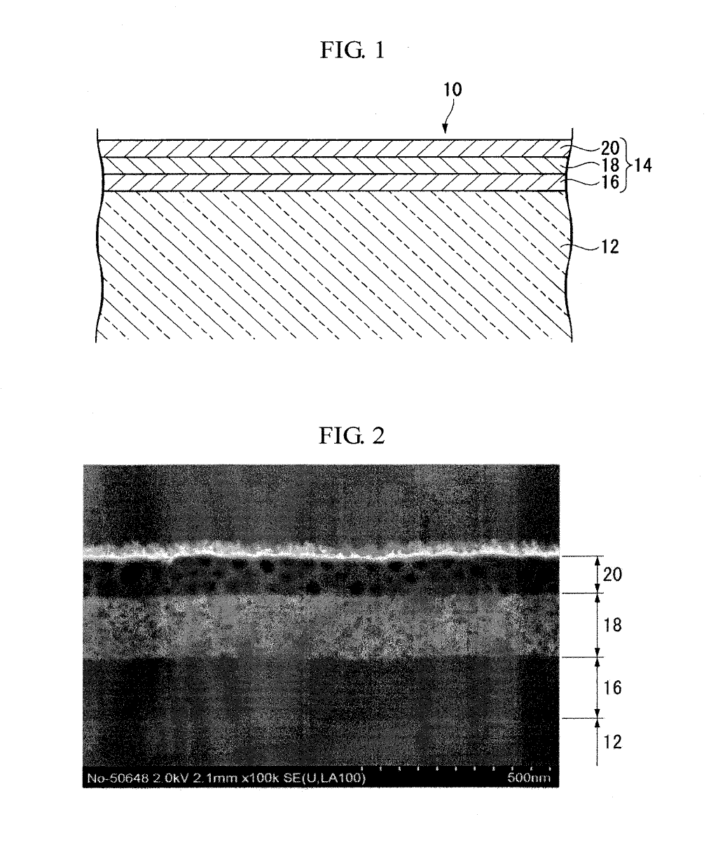

FIG. 1 is a cross-sectional view illustrating one example of the article having a low reflection film of the present invention (hereinafter simply referred to as “article” in some cases). FIG. 2 is a scanning electron micrograph showing a part of a cross-section of the article having a low reflection film of the present invention.

An article 10 contains a transparent substrate 12 and a low reflection film 14 formed on a surface of the transparent substrate 12.

The low reflection film 14 contains a first layer 16 formed on the surface of the transparent substrate 12, a second layer 18 formed on a surface of the first layer 16 at the side opposite the transparent substrate 12, and a third layer 20 formed on a surface of the second layer 18 at the side opposite the first layer 16.

The article of the present invention is characterized in that a refractive index n0 of the transparent substrate, a refractive index n1 of the first layer, a refractive index n2 of the second layer, and a refractive index n3 of the third layer satisfy the relationship of n3<n1<n0<n2. The reflectance of the low reflection film in the whole visible light region can be decreased by satisfying the relationship of n3<n1<n0<n2. On the other hand, in the low reflection film described in Patent Document 1 satisfying the relationship of n3<n2<n1, in the case where a low reflection film is prepared by setting n3 to the same value as that in the article of the present invention, such a low reflection film shows a larger reflectance than that of the low reflection film in the article of the present invention.

Furthermore, the article of the present invention satisfying the relationship of n3<n1<n0<n2 can suppress the reflectance of the low reflection film low even though if refractive index n3 of the third layer as an outermost surface layer is set relatively high (e.g., 1.27 or larger). For this reason, the low reflection film is enhanced in durability.

### (Transparent Substrate)

Examples of the form of the transparent substrate include plate, film and the like.

The transparent substrate may have an underlayer other than the low reflection film, such as various functional layers (e.g., an alkali barrier layer, an adhesion improving layer, a durability improving layer, etc.), previously formed on the surface of the transparent substrate body so long as the effect of the present invention is not impaired. The underlayer specifically includes, for example, layers having functions such as UV protection, IR protection, light scattering, wavelength conversion, prevention of static charge, or the like. It is preferred for exhibiting antireflection property sufficiently that the refractive index of the functional layer is set to a value between the refractive index of the transparent substrate and the refractive index of the first layer in the low reflection film.

The article of the present invention may have a layer having anti-glare effect provided between the transparent substrate body and the low reflection film. For example, a layer having RMS as surface roughness of 0.05 μm or larger and 0.25 μm or smaller and RSm as a mean length of a roughness curve element of 10 μm or larger and 40 μm or smaller can be provided as the layer having anti-glare effect. The layer having anti-glare effect may be formed by modifying the surface of the transparent substrate body itself, or may be formed by providing a layer having anti-glare effect on the transparent substrate body. The antireflection property of an article can be further enhanced by imparting the anti-glare effect, and this is preferred.

The “RMS as surface roughness” used herein is an average depth of irregularities from a reference surface (here, the surface of the transparent substrate body before surface treatment). The surface roughness is also called a root mean square roughness, and is sometimes indicated by Rq. Furthermore, the “RSm as a mean length of a roughness curve element” is a length obtained by, in a roughness curve contained in a reference length defined on the reference surface, averaging lengths on the reference surface, in each of which irregularities of one-period quantity are generated. RMS (μm) and RSm can be measured by a method according to the method defined in JIS B 0601 (2001).

Examples of the material of the transparent substrate (transparent substrate body in the case where an underlayer is formed) includes glass, resin and the like.

Examples of the glass include soda lime glass, borosilicate glass, aluminosilicate glass, alkali-free glass, and the like.

The sheet glass may be a smooth float sheet glass formed by a float process or the like, and may be a figured glass having irregularities on the surface thereof.

Examples of the resin include polyethylene terephthalate, polycarbonate, triacetyl cellulose, methyl polymethacrylate, and the like.

### (Low Reflection Film)

The thickness of the low reflection film is preferably from 100 nm to 700 nm, and more preferably from 200 nm to 500 nm. In the case where the thickness of the low reflection film is the lower limit of the above range or larger, the action as an interference film is sufficiently exhibited, and the reflectance of the low reflection film in the whole visible light region is sufficiently decreased. In the case where the film thickness of the low reflection film is the upper limit of the above range or smaller, cracks are difficult to occur in the low reflection film.

### (First Layer)

The refractive index n1 of the first layer is preferably from 1.35 to 1.47, and more preferably from 1.36 to 1.42. In the case where the refractive index n1 of the first layer is within the above range, the reflectance is further lowered in the whole visible light region.

The optimum value of the refractive index n1 of the first layer can be determined depending on the refractive index n0 of the transparent substrate and the refractive index n3 of the third layer.

As long as the refractive index n1 is within the above range, two or more layers may be provided as the first layer between the transparent substrate and the second layer.

The film thickness of the first layer (the total film thickness in the case where two or more layers are present as the first layer) is preferably from 10 nm to 300 nm, and more preferably from 50 nm to 200 nm. In the case where the film thickness of the first layer is the lower limit of the above range or larger, the action as an interference film is sufficiently exhibited and the reflectance of the low reflection film in the whole visible light region is sufficiently lowered. In the case where the film thickness of the first layer is the upper limit of the above range or smaller, cracks are difficult to occur in the first layer.

The first layer is preferably a layer containing SiO₂ as a main component, and more preferably a layer consisting essentially of SiO₂, from the standpoints of excellent chemical stability and excellent adhesiveness to the transparent substrate (glass) and the second layer.

Examples of the first layers include a layer containing a burned product of a hydrolyzate (sol-gel silica) of an alkoxysilane, a layer containing a burned product of silazane, and the like. The layer containing a burned product of a hydrolyzate of an alkoxysilane is more preferred.

Examples of the alkoxysilane include a tetraalkoxysilane (tetramethoxysilane, tetraethoxysilane, tetrapropoxysilane, tetrabutoxysilane, etc.), an alkoxysilane having a perfluoropolyether group (perfluoropolyether triethoxysilane, etc.), an alkoxysilane having a perfluoroalkyl group (perfluoroethyl triethoxysilane, etc.), an alkoxysilane having a vinyl group (vinyltrimethylsilane, vinyltriethoxysilane, etc.), an alkoxysilane having an epoxy group (2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, etc.), an alkoxysilane having an acryloyloxy group (3-acryloyloxypropyltrimethoxysilane, etc.), and the like.

The hydrolysis of the alkoxysilane can be performed by using water in a molar amount 4 or more times the alkoxysilane, and an acid or alkali as a catalyst, in the case of tetraalkoxysilane. Examples of the acid include an inorganic acid (HNO₃, H₂SO₄ HCl, etc.), an organic acid (formic acid, oxalic acid, monochloroacetic acid, dichloroacetic acid, trichloroacetic acid, etc.) and the like. Examples of the alkali include ammonia, sodium hydroxide, potassium hydroxide, and the like, The catalyst is preferably an acid from the standpoint of long-term storage stability of the hydrolyzate of the alkoxysilane. In the case where the alkoxysilane is used together with SiO₂ particles, the catalyst is preferably a material that does not disturb the dispersion of the SiO₂ particles.

The first layer may contain SiO₂ particles. In the case where the first layer contains SiO₂ particles, an irregular structure is formed on the surface of the first layer. As a result, in forming the second layer on the surface of the first layer by a wet coating method, wettability of a coating liquid is improved and the second layer having high uniformity can be formed.

Examples of the SiO₂ particles include hollow SiO₂ particles and solid SiO₂ particles, and the SiO₂ particles used are appropriately selected depending on the refractive index n1.

The SiO₂ particles may exist in any state that each particle is present in an independent manner, that each particle is connected to each other in a chain manner, and that each particle is aggregated.

The average primary particle diameter of the SiO₂ particles is preferably from 1 nm to 100 nm, and more preferably from 5 nm to 50 nm. In the case where the average primary particle diameter of the SiO₂ particles is the lower limit of the above range or larger, an irregular structure is easy to be formed on the surface of the first layer. In the case where the average primary particle diameter of the SiO₂ particles is the upper limit of the above range or smaller, light scattering at a film interface is difficult to occur.

### (Second Layer)

The refractive index n2 of the second layer is preferably from 1.59 to 1.71, and more preferably from 1.60 to 1.70. In the case where the refractive index n2 of the second layer is within the above range, the reflectance is further lowered in the whole visible light region.

The optimum value of the refractive index n2 of the second layer can be determined depending on the refractive index n0 of the transparent substrate and the refractive index n3 of the third layer.

As long as the refractive index n2 is within the above range, two or more layers may be provided as the second layer between the first layer and the third layer.

The film thickness of the second layer (the total film thickness in the case where two or more layers are present as the second layer) is preferably from 10 nm to 300 nm, and more preferably from 50 nm to 200 nm. In the case where the film thickness of the second layer is the lower limit of the above range or larger, the action as an interference film is sufficiently exhibited and the reflectance of the low reflection film in the whole visible light region is sufficiently lowered. In the case where the film thickness of the second layer is the upper limit of the above range or smaller, cracks are difficult to occur in the second layer.

The second layer is preferably a layer containing SiO₂ and a high refractive index material for controlling a refractive index, from the standpoint that the refractive index n2 of the second layer is easy to be set to the above range.

Examples of the high refractive index material include ZrO₂, TiO₂, Al₂O₃, SnO₂, CeO₂, Nb₂O₃, diamond, and the like. ZrO₂ is preferred.

The refractive index of SiO₂ is 1.46, and the refractive index of ZrO₂ is from 1.8 to 2.0 (varying depending on a heat treatment temperature). The refractive index n2 of the second layer can be controlled by a ratio between SiO₂ and ZrO₂. SiO₂ and ZrO₂ have small absorption (extinction coefficient) to visible light, and therefore are suitable for uses requiring high transmittance.

The second layer is preferably a layer having a matrix containing ZrO₂ in which solid SiO₂ particles are dispersed, from the standpoints of small absorption in a wide wavelength region and high transmission.

Examples of the matrix containing ZrO₂ include a burned product of a hydrolyzate of zirconium alkoxide; a burned product of a chelate compound such as zirconium acetylacetonate, zirconium acylate, zirconyl chloride, or zirconium lactate ammonium salt; and the like. A burned product of a hydrolyzate of zirconium alkoxide is preferred.

Examples of the zirconium alkoxide include zirconium tributoxymonoacetylacetonate, zirconium tetramethoxide, zirconium tetraethoxide, zirconium tetra n-propoxide, zirconium tetraisopropoxide, zirconium tetra n-butoxide, zirconium tetra tert-butoxide, zirconium tetra sec-butoxide, and the like.

The hydrolysis of zirconium alkoxide can be performed by using water in a molar amount 4 or more times the zirconium alkoxide, and an acid or alkali as a catalyst, in the case of tetraalkoxyzirconium. Examples of the acid include an inorganic acid (HNO₃, H₂SO₄, HCl, etc.), an organic acid (formic acid, oxalic acid, monochloroacetic acid, dichloroacetic acid, trichloroacetic acid, etc.) and the like. Examples of the alkali include ammonia, sodium hydroxide, potassium hydroxide, and the like. The catalyst is preferably an acid from the standpoint of long-term storage stability of the hydrolyzate of the zirconium alkoxide. In the case where the zirconium alkoxide is used together with SiO₂ particles, the catalyst is preferably a material that does not disturb the dispersion of SiO₂ particles.

The second layer may contain SiO₂ particles. In the case where the second layer contains SiO₂ particles, an irregular structure is formed on the surface of the second layer. As a result, in forming the third layer on the surface of the second layer by a wet coating method, wettability of a coating liquid is improved and the third layer having high uniformity can be formed.

Examples of the SiO₂ particles include hollow SiO₂ particles and solid SiO₂ particles, and the solid SiO₂ particles are preferred from that the refractive index n2 is easy to be adjusted to the above range.

The SiO₂ particles may exist in any state that each particle is present in an independent manner, that each particle is connected to each other in a chain manner, and that each particle is aggregated.

The average primary particle diameter of the SiO₂ particles is preferably from 1 nm to 100 nm, and more preferably from 5 nm to 60 nm. In the case where the average primary particle diameter of the SiO₂ particles is the lower limit of the above range or larger, an irregular structure is easy to be formed on the surface of the second layer. In the case where the average primary particle diameter of the SiO₂ particles is the upper limit of the above range or smaller, voids are difficult to be formed among the particles.

### (Third Layer)

The refractive index n3 of the third layer is preferably from 1.27 to 1.33, and more preferably from 1.28 to 1.32. In the case where the refractive index n3 of the third layer is the lower limit of the above range or larger, durability of the low reflection film is sufficiently increased. In the case where the refractive index n3 of the third layer is the upper limit of the above range or smaller, reflectance of the low reflection film in the whole visible light region is sufficiently decreased.

As long as the refractive index n3 of the third layer is within the above range, two or more layers may be provided as the third layer between the second layer and the air.

The film thickness of the third layer (the total film thickness in the case where two or more layers are present as the third layer) is preferably from 10 nm to 300 nm, and more preferably from 50 nm to 200 rim. In the case where the film thickness of the third layer is the lower limit of the above range or larger, the action as an interference film is sufficiently exhibited and the reflectance of the low reflection film in the whole visible light region is sufficiently lowered. In the case where the film thickness of the third layer is the upper limit of the above range or smaller, cracks are difficult to occur in the third layer.

The third layer is preferably a layer containing SiO₂ as a main component, and more preferably a layer consisting essentially of SiO₂, from the standpoints of low refractive index, excellent chemical stability and excellent adhesiveness to the second layer.

The third layer is preferably a layer having a matrix containing SiO₂, and containing SiO₂ particles, from the standpoints that the refractive index n3 of the third layer is easy to be adjusted to the above range.

Examples of the matrix containing SiO₂ include a burned product of a hydrolyzate of an alkoxysilane (sol-gel silica), a burned product of silazane and the like. The burned product of a hydrolyzate of an alkoxysilane is preferred. Examples of the alkoxysilane include the alkoxysilanes described before.

Examples of the SiO₂ particles include hollow SiO₂ particles and solid SiO₂ particles. Hollow SiO₂ particles are preferred from the standpoints that the refractive index n3 of the third layer is easy to be adjusted to the above range.

The hollow SiO₂ particles may exist in any state that each particle is present in an independent manner, that each particle is connected to each other in a chain manner, and that each particle is aggregated.

The average primary particle diameter of the hollow SiO₂ particles is preferably from 5 nm to 150 nm, and more preferably from 50 nm to 100 nm. In the case where the average primary particle diameter of the hollow SiO₂ particles is the lower limit of the above range or larger, the reflectance of the low reflection film in the whole visible light region is sufficiently decreased. In the case where the average primary particle diameter of the hollow SiO₂ particles is the upper limit of the above range or smaller, haze of the low reflection film can be suppressed low.

### (Production Method of Article)

The article of the present invention can be produced by, for example, forming each layer on the transparent substrate by a wet coating method or a dry coating method.

In the case of using a wet coating method, the article can be produced by, for example, successively applying each coating liquid for forming each layer to the transparent substrate, preheating as necessary, and finally burning.

Examples of the coating liquid include a solution of a matrix precursor (a solution of a hydrolyzate of alkoxysilane, a solution of silazane, etc.); a mixture of a dispersion of SiO₂ particles and a solution of a matrix precursor (a solution of a hydrolyzate of alkoxysilane, a solution of silazane, a solution of zirconium alkoxide, etc.); and the like.

The coating liquid may contain a surfactant for enhancing leveling property, a metal compound for enhancing durability of a coating film, and the like.

Examples of a dispersion medium of the dispersion of SiO₂ particles include water, alcohols, ketones, ethers, cellosolves, esters, glycol ethers, nitrogen-containing compounds, sulfur-containing compounds, and the like.

A dispersion medium of the coating liquid is preferably a mixed solvent of water and an alcohol (methanol, ethanol, isopropanol, butanol, diacetone alcohol, etc.).

Examples of the coating method include the conventional wet coating methods (a spin coating method, a spray coating method, a dip coating method, a die coating method, a curtain coating method, a screen coating method, an ink jetting method, a flow coating method, a gravure coating method, a bar coating method, a flexo coating method, a slit coating method, a roll coating method, etc.) and the like.

The coating temperature is preferably from room temperature to 200° C., and more preferably from room temperature to 150° C.

The burning temperature is preferably 30° C. or higher, and is appropriately determined depending on materials of a transparent substrate, particles and matrix.

In the case where the material of the transparent substrate is a resin, the burning temperature is set to a heat-resistant temperature of the resin or lower, but sufficient antireflection effect can be obtained even though the burning temperature is such a temperature.

In the case where the material of the transparent substrate is a glass, the burning temperature is preferably from 200° C. to a softening temperature of the glass or lower. In the case where the burning temperature is 200° C. or higher, the first layer is densified to enhance durability. In the case where the burning temperature is the softening temperature of the glass or lower (e.g., 800° C. or lower), vacancies in the first layer do not disappear and reflectance of the low reflection film is sufficiently decreased.

### (Action Mechanism)

In the article of the present invention described above, the refractive index n0 of the transparent substrate, the refractive index n1 of the first layer, the refractive index n2 of the second layer, and the refractive index n3 of the third layer satisfy the relationship of n3<n1<n0<n2. Therefore, the reflectance of the low reflection film in the whole visible light region is decreased.

Furthermore, since the article of the present invention described above satisfies the relationship of n3<n1<n0<n2, even though the refractive index n3 of the third layer as an outermost surface layer is relatively high (e.g., 1.25 or higher), the reflectance of the low reflection film can be suppressed low. As a result, durability of the low reflection film is enhanced.

### EXAMPLES

The present invention is described in more detail below by reference to Examples. Examples 1 to 16 are Invention Examples, and Examples 17 and 18 are Comparative Examples.

### (Measurement Method and Evaluation Method)

### (Average Primary Particle Diameter of Particles)

A dispersion of hollow SiO₂ particles was diluted with ethanol to 0.1 mass %, sampled on a collodion film, and observed with a transmission electron microscope (H-9000, manufactured by Hitachi, Ltd.). Therefrom, 100 particles were randomly selected, and a particle diameter of each hollow SiO₂ particle was measured. Particle diameters of the 100 hollow SiO₂ particles were averaged to determine an average primary particle diameter of the hollow SiO₂ particles.

An average primary particle diameter of particles other than the hollow SiO₂ particles was calculated by assuming that the spherical particles were uniformly dispersed in a carrier, and converting from a specific surface area measured by a BET method and a volume of spherical particles.

### (Refractive Index)

The refractive index of each layer was measured at a wavelength of 550 nm by using an ellipsometer (M-2000DI, manufactured by J. A. Woollam) in a single layer film of each layer formed on the surface of a sheet glass.

### (Film Thickness)

The film thickness of each layer was obtained by measuring film thicknesses at 10 places on an image obtained by observing a cross-section of an article having a low reflection film with a scanning electron microscope, and averaging the film thicknesses at 10 places.

### (Reflectance)

The reflectance of the low reflection film was measured by using a spectrophotometer (U-4100, manufactured by Hitachi, Ltd.). The average value indicates an average value of values measured at intervals of 5 nm from 400 nm to 750 nm.

### (Adhesiveness)

Based on MIL-C-675C Standard, an eraser abrasion test was performed under a load of 9.8N by using a plane abrasion tester (PA-300A, manufactured by Daiei Kagaku Seiki Co., Ltd.), and adhesiveness was evaluated by the difference ΔR (absolute value) between average reflectances at a wavelength of from 400 nm to 800 nm before and after the test.

### (Raw Material Liquid)

The details of the raw material liquids shown in Table 1 are as follows.

TABLE 1

| Raw | | Solid content concentration |
|---|---|---|
| material | | in terms of oxides |
| liquid | Solution/dispersion | (mass %) |
| a | SiO₂ matrix precursor solution | 3 |
| b | Solid SiO₂ particle dispersion | 30 |
| c | Hollow SiO₂ particle dispersion | 20 |
| d | ZrO₂ matrix precursor solution | 17 |
| e | TiO₂ matrix precursor solution | 9 |
| f | Al₂O₃ matrix precursor solution | 12 |
| g | Chain solid SiO₂ dispersion | 15 |

### (Raw Material Liquid a)

Raw material liquid a as a SiO₂ matrix precursor solution was prepared as follows.

While stirring 77.75 g of ethanol at 25° C., thereto were added 6.45 g of pure water and 10.4 g of tetraethoxysilane (solid content amount in terms of SiO₂: 28.84 mass %), and then, thereto was further added 5.40 g of a 10 mass % nitric acid aqueous solution, followed by stirring for 60 minutes. Thus, a solution of a hydrolyzate of alkoxysilane (solid content concentration in terms of SiO₂: 3 mass %) was obtained.

### (Raw Material Liquid b)

Dispersion of solid SiO₂ particles (manufactured by Nissan Chemical Industries, Ltd., organosilica sol, IPA-ST, solid content concentration in terms of SiO₂: 30 mass %, average primary particle diameter: 10 nm to 15 nm, dispersion medium: isopropanol).

### (Raw Material Liquid c)

Dispersion of hollow SiO₂ particles (manufactured by JGC C&C, hollow silica sol, SURURIA 4110, solid content concentration in terms of SiO₂: 20 mass %, average primary particle diameter: 60 nm, dispersion medium: isopropanol).

### (Raw Material Liquid d)

ZrO₂ matrix precursor solution (manufactured by Matsumoto Fine Chemical Co., Ltd., zirconium tributoxymonoacetyl acetonate, solid content concentration in terms of ZrO₂: 17 mass %, solvent: toluene, 1-butanol, butyl acetate)

### (Raw Material Liquid e)

TiO₂ matrix precursor solution (manufactured by Matsumoto Fine Chemical Co., Ltd., titanium alkoxide oligomer, solid content concentration in terms of TiO₂: 9 mass %, solvent: 1-butanol).

### (Raw Material Liquid f)

Al₂O₃ matrix precursor solution (manufactured by Matsumoto Fine Chemical Co., Ltd., aluminum tris(ethyl acetoacetate), solid content concentration in terms of Al₂O₃: 12 mass %, solvent: 2-butanol).

### (Raw Material Liquid g)

Dispersion of chain solid SiO₂ particles (manufactured by Nissan Chemical Industries, Ltd., organosilica sol, IPA-ST-UP, solid content concentration in terms of SiO₂: 15 mass %, average primary particle diameter: 40 nm to 100 nm, dispersion medium: isopropanol).

### (Preparation of Coating Solution)

(Coating liquid A)

While stirring 39.00 g of isopropanol, thereto were added 60.00 g of the raw material liquid a and 1.00 g of the raw material liquid b, to prepare a coating liquid A. The coating liquid A was applied to the surface of a sheet glass (refractive index: 1.52) by spin coating (500 rpm, 20 seconds), and burned at 650° C. for 10 minutes to prepare a single layer film. Refractive index of the film was measured. Addition amount of each raw material liquid, solid content concentration of the coating liquid and a refractive index of the single layer film are shown in Table 2.

(Coating liquids B to S)

Coating liquids B to S were prepared in the same manner as in the coating liquid A, except that the addition amount of each raw material liquid was changed as shown in Table 2, and each single layer film was formed. Solid content concentration of coating liquids and refractive index of single layer films are shown in Table 2.

TABLE 2

| | | | | | | | Proportion | | | | |
|---|---|---|---|---|---|---|---|---|---|---|---|
| | | | | | | | (mass %) of | | | | |
| | | | | | | | solid content | | | | |
| | | | | | | | in terms of oxide | | | | |
| | | | | | | | derived from each | | | | |
| | | | | | | | raw material | | Single layer film | | |
| | | | | | | Solid content | liquid in X | | | | Material |
| | Raw material | | | | | concentration X | | Derived | | Material | derived |
| | liquid | | Addition amount (g) | | | (mass %) in terms | Derived | from | | derived | from |
| Coating | First | Second | | First | Second | of oxide of | from first | second | Refractive | from first | second |
| liquid | liquid | liquid | IPA | liquid | liquid | coating liquid | liquid | liquid | index | liquid | liquid |
| A | a | c | 39.00 | 60.00 | 1.00 | 2 | 90 | 10 | 1.42 | SiO₂ | Hollow |
| | | | | | | | | | | | particle |
| B | a | c | 56.00 | 40.00 | 4.00 | 2 | 60 | 40 | 1.36 | SiO₂ | Hollow |
| | | | | | | | | | | | particle |
| C | a | b | 75.33 | 20.00 | 4.67 | 2 | 30 | 70 | 1.46 | SiO₂ | Solid |
| | | | | | | | | | | | particle |
| D | a | c | 58.83 | 36.67 | 4.50 | 2 | 55 | 45 | 1.34 | SiO₂ | Hollow |
| | | | | | | | | | | | particle |
| E | a | d | 36.08 | 63.33 | 0.59 | 2 | 95 | 5 | 1.48 | SiO₂ | ZrO₂ |
| F | a | d | 66.27 | 26.67 | 7.06 | 2 | 40 | 60 | 1.66 | SiO₂ | ZrO₂ |
| G | a | d | 60.78 | 33.33 | 5.88 | 2 | 50 | 50 | 1.60 | SiO₂ | ZrO₂ |
| H | a | d | 71.76 | 20.00 | 8.24 | 2 | 30 | 70 | 1.70 | SiO2 | ZrO₂ |
| I | a | e | 51.11 | 40.00 | 8.89 | 2 | 60 | 40 | 1.66 | SiO₂ | TiO₂ |
| J | d | f | 86.52 | 7.65 | 5.83 | 2 | 65 | 35 | 1.66 | ZrO₂ | Al₂O₃ |
| K | a | d | 55.29 | 40.00 | 4.71 | 2 | 60 | 40 | 1.58 | SiO₂ | ZrO₂ |
| L | b | d | 92.06 | 5.00 | 2.94 | 2 | 75 | 25 | 1.72 | Solid | ZrO₂ |
| | | | | | | | | | | particle | |
| M | a | c | 58.83 | 36.67 | 4.50 | 2 | 55 | 45 | 1.34 | SiO₂ | Hollow |
| | | | | | | | | | | | particle |
| N | e | — | 77.78 | 22.22 | — | 2 | 100 | — | 2.00 | TiO₂ | — |
| O | a | c | 64.50 | 30.00 | 5.50 | 2 | 45 | 55 | 1.30 | SiO₂ | Hollow |
| | | | | | | | | | | | particle |
| P | a | c | 67.33 | 26.67 | 6.00 | 2 | 40 | 60 | 1.28 | SiO₂ | Hollow |
| | | | | | | | | | | | particle |
| Q | a | c | 61.67 | 33.33 | 5.00 | 2 | 50 | 50 | 1.32 | SiO₂ | Hollow |
| | | | | | | | | | | | particle |
| R | a | c | 70.17 | 23.33 | 6.50 | 2 | 35 | 65 | 1.26 | SiO₂ | Hollow |
| | | | | | | | | | | | particle |
| S | a | g | 76.00 | 13.33 | 10.67 | 2 | 20 | 80 | 1.30 | SiO₂ | Chain |
| | | | | | | | | | | | particle |

IPA: Isopanol,
solid particle: solid SiO₂ particle,
hollow particle: hollow SiO₂ particle,
chain particle: chain solid SiO₂ particle.

### (Production of Article)

### Examples 1 to 18

A sheet glass (manufactured by Asahi Glass Co., Ltd., alkali-free glass EN-Al, size: 100 mm×100mm, thickness: 3.2 mm, refractive index n0: 1.52) was prepared as a transparent substrate. The surface of the sheet glass was polished with a cerium oxide aqueous dispersion, and cerium oxide was washed away with water. The surface was rinsed with ion-exchanged water and then dried.

A coating liquid for forming a first layer shown in Table 3 was applied to the surface of the sheet glass by spin coating (500 rpm, 20 seconds). The sheet glass after the application was preheated in a preheating furnace, and a coating liquid for forming a second layer shown in Table 3 was applied to the sheet glass by spin coating (500 rpm, 20 seconds). The sheet glass after the application was preheated in a preheating furnace, and a coating liquid for forming a third layer shown in Table 3 was applied to the sheet glass by spin coating (500 rpm, 20 seconds). The sheet glass was burned at 650° C. for 10 minutes, and an article having a low reflection film formed thereon was obtained. Refractive index and film thickness of each layer are shown in Table 3, and evaluation results of each article are shown in Table 4.

TABLE 3

| | Transparent | First layer | | | Second layer | | | Third layer | | |
|---|---|---|---|---|---|---|---|---|---|---|
| | substrate | | Film thickness | Coating | | Film thickness | Coating | | Film thickness | Coating |
| Example | n0 | n1 | (nm) | liquid | n2 | (nm) | liquid | n3 | (nm) | liquid |
| 1 | 1.52 | 1.42 | 184 | A | 1.66 | 157 | F | 1.30 | 100 | O |
| 2 | 1.52 | 1.36 | 191 | B | 1.66 | 154 | F | 1.30 | 99 | O |
| 3 | 1.52 | 1.46 | 181 | C | 1.66 | 159 | F | 1.30 | 102 | O |
| 4 | 1.52 | 1.42 | 180 | A | 1.60 | 162 | G | 1.30 | 100 | O |
| 5 | 1.52 | 1.42 | 186 | A | 1.70 | 155 | H | 1.30 | 101 | O |
| 6 | 1.52 | 1.42 | 185 | A | 1.66 | 158 | I | 1.30 | 101 | O |
| 7 | 1.52 | 1.42 | 184 | A | 1.66 | 156 | J | 1.30 | 99 | O |
| 8 | 1.52 | 1.42 | 186 | A | 1.66 | 159 | F | 1.28 | 103 | P |
| 9 | 1.52 | 1.42 | 179 | A | 1.66 | 157 | F | 1.32 | 99 | Q |
| 10 | 1.52 | 1.42 | 185 | A | 1.66 | 157 | F | 1.30 | 101 | S |
| 11 | 1.52 | 1.34 | 196 | D | 1.70 | 153 | H | 1.30 | 100 | O |
| 12 | 1.52 | 1.48 | 180 | E | 1.60 | 161 | G | 1.30 | 102 | O |
| 13 | 1.52 | 1.42 | 161 | A | 1.58 | 152 | K | 1.30 | 96 | O |
| 14 | 1.52 | 1.36 | 191 | B | 1.72 | 153 | L | 1.30 | 101 | O |
| 15 | 1.52 | 1.42 | 186 | A | 1.60 | 163 | G | 1.26 | 105 | R |
| 16 | 1.52 | 1.46 | 175 | C | 1.66 | 155 | F | 1.34 | 98 | M |
| 17 | 1.52 | 1.46 | 97 | C | 1.34 | 169 | M | 1.30 | 119 | O |
| 18 | 1.52 | 1.66 | 100 | F | 2.00 | 136 | N | 1.34 | 110 | M |

TABLE 4

| | Reflectance (%) of light of each wavelength | | | | | | |
|---|---|---|---|---|---|---|---|
| | 750 | 700 | 550 | 435 | 400 | Average | Adhesiveness |
| Example | nm | nm | nm | nm | nm | value | ΔR (%) |
| 1 | 0.32 | 0.03 | 0.33 | 0.22 | 0.18 | 0.23 | 0.25 |
| 2 | 0.36 | 0.02 | 0.37 | 0.35 | 0.35 | 0.32 | 0.27 |
| 3 | 0.41 | 0.10 | 0.30 | 0.12 | 0.49 | 0.22 | 0.23 |
| 4 | 0.30 | 0.16 | 0.35 | 0.42 | 0.18 | 0.32 | 0.28 |
| 5 | 0.42 | 0.02 | 0.31 | 0.08 | 0.49 | 0.21 | 0.24 |
| 6 | 0.27 | 0.02 | 0.32 | 0.18 | 0.27 | 0.23 | 0.31 |
| 7 | 0.39 | 0.04 | 0.33 | 0.25 | 0.10 | 0.24 | 0.35 |
| 8 | 0.35 | 0.03 | 0.17 | 0.07 | 0.48 | 0.15 | 0.48 |
| 9 | 0.40 | 0.12 | 0.48 | 0.26 | 0.29 | 0.32 | 0.18 |
| 10 | 0.29 | 0.02 | 0.32 | 0.21 | 0.22 | 0.23 | 0.38 |
| 11 | 0.43 | 0.08 | 0.36 | 0.34 | 0.79 | 0.37 | 0.28 |
| 12 | 0.50 | 0.22 | 0.28 | 0.27 | 0.51 | 0.28 | 0.25 |
| 13 | 0.71 | 0.23 | 0.52 | 0.50 | 0.62 | 0.38 | 0.24 |
| 14 | 0.50 | 0.03 | 0.33 | 0.16 | 0.61 | 0.26 | 0.30 |
| 15 | 0.30 | 0.04 | 0.08 | 0.08 | 0.45 | 0.12 | 0.62 |
| 16 | 0.53 | 0.18 | 0.68 | 0.30 | 0.35 | 0.42 | 0.13 |
| 17 | 2.24 | 1.96 | 1.02 | 1.35 | 2.47 | 1.44 | 0.36 |
| 18 | 0.63 | 0.26 | 0.46 | 1.21 | 5.93 | 0.67 | 0.15 |

In the articles of Examples 1 to 16, the refractive index n0 of the transparent substrate, the refractive index n1 of the first layer, the refractive index n2 of the second layer, and the refractive index n3 of the third layer satisfy the relationship of n3<n1<n0<n2. Therefore, the low reflection film has low reflectance in the whole visible light region, and has high durability.

In the article of Example 17, reflectances have the relationship of n3<n2<n1<n0, and n3 is not sufficiently low. Therefore, the reflectance of light having each wavelength is high.

In the article of Example 18, reflectances have the relationship of n3<n0<n1<n2. Therefore, the reflectance of light having a wavelength of 400 nm is high.

While the present invention has been described in detail and by reference to the specific embodiments, it is apparent to one skilled in the art that various modifications or changes can be made without departing from the spirit and scope of the present invention.

The present application is based on Japanese Patent Application No. 2016-077257 filed on Apr. 7, 2016, which contents are incorporated herein by reference.

### INDUSTRIAL APPLICABILITY

The article having a low reflection film according to the present invention is useful as cover glasses for solar cells, transparent parts for vehicles (a headlight cover, a wing mirror, a front transparent substrate, a side transparent substrate, a rear transparent substrate, etc.), transparent parts for vehicles (instrument panel surface, etc.), various meters, windows for building, display windows, displays (a notebook-size personal computer, a monitor, LCD, PDP, ELD, CRT, PDA, etc.), LCD color filters, substrates for touch panels, pick-up lenses, optical lenses, eyeglass lenses, camera parts, video camera parts, cover substrates for CCD, optical fibers, copying machine parts, transparent substrates for solar cells, mobile cell windows, backlight unit parts (e.g., a light guide plate, a cold cathode tube, etc.), liquid crystal brightness-improving films of backlight unit parts (e.g., a prism, a semi-transmissive film, etc.), projectors, optical members of projectors (an inorganic polarizing plate, etc.) such as a head-up display, liquid crystal brightness-improving films, organic EL light emitter parts, inorganic EL light emitter parts, fluorescent light emitter parts, optical filters, other various optical parts, lighting lamps, covers for lighting equipments, amplified laser light sources, antireflective films, polarizing films, agricultural films, and the like.

### DESCRIPTION OF REFERENCE NUMERALS AND SIGNS

10: Article

12: Transparent substrate

14: Low reflection film

16: First layer

18: Second layer

20: Third layer

1. An article, comprising a transparent substrate, and
a low reflection film provided on a surface of the transparent substrate,
wherein the low reflection film comprises a first layer provided on the surface of the transparent substrate, a second layer contacting a surface of the first layer at a side opposite to the transparent substrate, and a third layer contacting a surface of the second layer at a side opposite to the first layer, and
wherein the transparent substrate has a refractive index n0, the first layer has a refractive index n1, the second layer has a refractive index n2, and the third layer has a refractive index n3, and n0, n1, n2, and n3 satisfy the relationship n3<n1<n0<n2.

2. The article according to claim 1, wherein
each of the first layer, the second layer, and the third layer has a film thickness of from 10 nm to 300 nm, and
the low reflection film has a film thickness of from 100 nm to 700 nm.

3. The article according to claim 1, wherein the refractive index n3 of the third layer is from 1.27 to 1.33.

4. The article according to claim 1, wherein
the refractive index n1 of the first layer is from 1.35 to 1.47, and
the refractive index n2 of the second layer is from 1.59 to 1.71.

5. The article according to claim 1, wherein the second layer contains SiO₂ and ZrO₂.

6. The article according to claim 5, wherein the second layer has a matrix containing ZrO₂ and solid SiO₂ particles are dispersed therein.

7. The article according to claim 1, further comprising:
a functional underlayer, which has a refractive index between the refractive index n0 of the transparent substrate and the refractive index n1 of the first layer of the low reflection film.

8. The article according to claim 1, further comprising:
an anti-glare layer between the transparent substrate and the low reflection film.

9. The article according to claim 8, wherein the anti-glare layer has RMS as surface roughness of 0.05 μm or larger and 0.25 μm or smaller and RSm as a mean length of a roughness curve element of 10 μm or larger and 40 μm or smaller.

10. The article according to claim 1, wherein the transparent substrate is glass or resin.

11. The article according to claim 1, wherein the first layer contains SiO₂.

12. The article according to claim 1, wherein the first layer contains hollow or solid SiO₂ particles.

13. The article according to claim 12, wherein the SiO₂ particles have an average primary particle diameter of from 1 nm to 100 nm.

14. The article according to claim 1, wherein the third layer contains SiO₂.

15. The article according to claim 1, wherein the third layer comprises a matrix containing SiO₂.

16. The article according to claim 1, wherein the third layer comprises SiO₂ particles.

17. The article according to claim 16, wherein the SiO₂ particles are hollow and have an average primary particle diameter of from 5 nm to 150 nm.
